(19) United States
(12) Patent Application Publication
(10) Pub. No.: US 2025/0346772 A1
(43) Pub. Date: Nov. 13, 2025

(54) SOFT PIGMENTED CONTINUOUS INK JET INK COMPOSITIONS

(71) Applicant: Videojet Technologies Inc., Wood Dale, IL (US)

(72) Inventors: Fengfei Xiao, Wood Dale, IL (US); Godwin Deng, Wood Dale, IL (US); Yongman Kim, Wood Dale, IL (US); Jeffrey Pierce, Wood Dale, IL (US); Linfang Zhu, Wood Dale, IL (US)

(73) Assignee: Videojet Technologies Inc., Wood Dale, IL (US)

(21) Appl. No.: 19/279,082

(22) Filed: Jul. 24, 2025

Related U.S. Application Data
(63) Continuation of application No. PCT/US2024/012928, filed on Jan. 25, 2024.
(60) Provisional application No. 63/441,015, filed on Jan. 25, 2023.

(51) Int. Cl. C09D 11/322; C08K 5/3462; C08K 5/3475; C08K 5/435; C08K 5/52; C08K 5/5419; C08K 5/5435; C09D 11/38; C09D 11/52

(52) U.S. Cl. CPC C09D 11/322; C08K 5/3462; C08K 5/3475; C08K 5/435; C08K 5/5205; C08K 5/5419; C08K 5/5435; C09D 11/38; C09D 11/52; C08K 2201/005; C08K 2201/011

(57) ABSTRACT

Described herein are soft pigmented continuous ink jet ink compositions comprising an organic pigment, a solvent, a binder resin, and a conductive agent, wherein the organic pigment comprises particles having a particle size mean of about 100 nm to about 230 nm and a cumulative 99% particle diameter (D99) of less than about 600 nm.

### CROSS REFERENCE TO RELATED APPLICATIONS

This application is a continuation of PCT application No. PCT/US2024/012928, filed Jan. 25, 2024, which claims the benefit of priority to U.S. Provisional Patent Application No. 63/441,015 filed Jan. 25, 2023, which is incorporated herein by reference, in its entirety for any and all purposes.

### FIELD

The present technology generally relates to ink compositions for use in printers, and in particular to soft pigmented continuous ink jet ink compositions that include an organic pigment, a solvent, a binder resin, and a conductive agent, wherein the organic pigment comprises particles having a particle size mean of about 100 nm to about 230 nm and a cumulative 99% particle diameter (D99) of less than about 600 nm.

### BACKGROUND

Pigments are often chosen as ink colorants due to their performance advantages such as opacity, transfer resistance, lightfastness, heat resistance, etc. Inks may also be comprised of dye based colorants which are soluble species, but pigments are insoluble particles which are suspended in the ink. Historically, conventional pigments negatively impacted inkjet system reliability by physical settling which may lead to restricted flow paths within the ink system including the sensitive microscopic inkjet nozzles wherefrom droplet flow is established. Pigments further are known to disrupt clean drop break-off during the drop jetting event. Hence, pigments must be carefully dispersed and are typically produced in a concentrated dispersion which is let-down into the ink vehicle. Key pigment attributes include an average particle size, the particle size distribution, and pigment specific gravity. For example, it is known in the art that using inks with relatively low particle size and relatively narrow size distribution can improve inkjet performance. However, even the best conventional dispersions may not yield optimal performance particularly in continuous ink jet (CIJ) inks. CIJ requires that the drop breakoff event be stable and exceedingly repeatable, in part because, for CIJ, drops need be generated at exceptionally high rates as compared with other inkjet technologies. Knowing the difficulties involved, ‘pigment’ friendly CIJ printers have been designed to minimize the impact of pigment sedimentation in the ink system. Pigmented printers may further have design accommodations that improve drop breakoff stability or consistency. However, CIJ printers are continually being designed to print with differently engineered drop generators, at ever increasing drop generation rates (i.e., requiring increasingly better drop breakoff), and with different ink chemistries (i.e., with different pigments), each of which can negatively influence impact drop breakoff and system reliability.

To provide high contrast on dark surfaces, TiO₂ inorganic pigment is often used because it can exhibit a very high level of opacity when employed with high enough pigment content in the inkjet ink. TiO₂ based inks are especially detrimental to printer reliability because TiO₂ has high specific gravity and therefore settles quickly within the ink system and can be difficult to redisperse after sedimentation. In addition, TiO₂ inks often have mean particle sizes of about 300 nm, which can negatively impact reliable jetting. Inorganic pigments such as TiO₂ are often referred to as hard pigments. As such, there remains a need to develop pigmented continuous ink jet (CIJ) inks that have good opacity and yet are more reliable than TiO₂ based inks.

When formulated as CIJ inks, organic pigments (also known as soft pigments) exhibit lower specific gravities and therefore, tend to settle much slower. When these organic pigments do settle, they tend to redisperse more easily than hard inorganic pigments. In fact, these inks have been found to function well in printers with little or no accommodations for pigments (e.g., a ‘dye based printer’) which can lead to simpler and cheaper CIJ opaque inkjet solutions for the marketplace. However, conventional soft pigmented inks for CIJ tend to have an average particle size and particle size distribution similar to TiO₂ inks so while they might operate in dye based printers with less tendency to clog the ink system or nozzles, overall system reliability is not improved. As such, there remains a need to develop pigmented continuous ink jet (CIJ) inks that have great opacity and operate reliably in simpler inkjet systems.

This disclosure addresses these needs by providing soft pigmented continuous ink jet ink compositions having both excellent opacity and printer reliability with no required specific accommodations for pigmented inks. Specifically, the ink jet compositions described herein achieve the desired properties by having a certain pigment type, a certain pigment size and particle size distribution.

### SUMMARY

Provided in one aspect is an ink jet ink composition comprising:
an organic pigment,
a solvent,
a binder resin, and
a conductive agent,
   wherein the organic pigment comprises particles having a particle size mean of about 100 nm to about 230 nm and a cumulative 99% particle diameter (D99) of less than about 600 nm.

In some embodiments, the organic pigment comprises particles having a particle size mean of about 120 nm to about 230 nm and a cumulative 99% particle diameter (D99) of less than about 500 nm. In some embodiments, the organic pigment comprises particles having a particle size mean of about 150 nm to about 230 nm and a cumulative 99% particle diameter (D99) of less than about 500 nm. In some embodiments, the organic pigment comprises particles having a particle size mean of about 170 nm and a cumulative 99% particle diameter (D99) of less than about 500 nm. In some embodiments, the organic pigment comprises particles having a particle size mean of about 120 nm to about 200 nm and a cumulative 99% particle diameter (D99) of less than about 600 nm. In some embodiments, the organic pigment comprises particles having a particle size mean of about 120 nm to about 200 nm and a cumulative 99% particle diameter (D99) of less than about 510 nm. In some embodiments, the organic pigment comprises particles having a particle size mean of about 170 nm and a cumulative 99% particle diameter (D99) of less than about 510 nm.

In some embodiments, the organic pigment is a yellow organic pigment, an orange organic pigment, a red organic pigment or any combination of said colored pigments. In some embodiments, the organic pigment is a yellow organic pigment selected from one or more of C.I. pigment yellow 83, C.I. pigment yellow 138, C.I. pigment yellow 139, C.I. pigment yellow 151, C.I. pigment yellow 170, C.I. pigment yellow 181, and C.I. pigment yellow 194. In some embodiments, the yellow organic pigment is C.I. pigment yellow 139.

In some embodiments, the organic pigment is present in amount of from about 1% to about 15% by weight of the composition. In some embodiments, the organic pigment is present in amount of from about 3% to about 10% by weight of the composition. In some embodiments, the organic pigment is present in amount of from about 3% to about 8.5% by weight of the composition.

In some embodiments, the solvent comprises one or more of ketones, esters, alcohols, lactates, glycols, glycol ethers, glycol ether acetates, and glycol ether esters. In some embodiments, the solvent comprises one or more of acetone, butanone (methyl ethyl ketone), 3-methyl-2-butanone (methyl isopropyl ketone), 2-pentanone (methyl propyl ketone), 3-pentanone (diethyl ketone), methyl isobutyl ketone, cyclopentanone, cyclohexanone, ethanol, propanol, 2-propanol (isopropanol), 1-butanol, 2-butanol, methyl acetate, ethyl acetate, isopropyl acetate, methyl lactate, ethyl lactate, butyl lactate, propylene glycol, glycerol, and propylene glycol methyl ether acetate. In other embodiments, the solvent comprises one or more of methyl ethyl ketone, methyl propyl ketone, diethyl ketone, methyl isopropyl ketone, cyclopentanone, acetone, ethanol, methyl acetate, ethyl acetate, butyl lactate, propylene glycol, and propylene glycol methyl ether acetate.

In some embodiments, the solvent is present in an amount of at least about 50% by weight of the composition. In some embodiments, the solvent is present in an amount of from about 50% to about 90% by weight of the composition.

In some embodiments, the binder resin comprises one or more of acrylic resins, vinyl chloride/vinyl acetate copolymers resins, polyesters, polyvinylbutyral resins, cellulose-based resins, polyurethane resins, silicone resins, modified rosin resins, phenolic resins, polyamide resins, cellulose ester resins, cellulose nitrate resins, polymaleic anhydride resins, acetal polymers, styrene/methacrylate copolymers, aldehyde resins, copolymers of styrene and allyl alcohols, epoxies, polyhydroxystyrenes and polyketone resins. In some embodiments, the binder resin comprises one or more of acrylic resins, vinyl chloride/vinyl acetate copolymers, silicone resins, modified rosin resins, and cellulose ester resins.

In some embodiments, the binder resin is present in an amount of from about 5% to about 25% by weight of the composition.

In some embodiments, the conductive agent comprises an alkylammonium salt with at least one carbon group substituent comprising 4 carbon atoms or more, such as a butyl substituent. In some embodiments, the conductive agent comprises one or more of tetrabutylammonium hexafluorophosphate, tetrapropylammonium hexafluorophosphate, tetraethylammonium hexafluorophosphate, tetramethylammonium hexafluorophosphate, tetrabutylammonium tetraphenylborate, tetrabutylammonium bromide, and tetrabutylammonium tetrabutylborate. In some embodiments, the conductive agent comprises tetrabutylammonium hexafluorophosphate.

In some embodiments, the conductive agent is present in an amount of from about 0.5% to about 5% by weight of the composition. In some embodiments, the conductive agent is present in an amount of from about 1% to about 2% by weight of the composition.

In some embodiments, any one of the ink jet ink compositions described herein further comprises one or more of a humectant, a co-solvent, a co-resin, a defoamer, an adhesion promoter, a plasticizer, a dispersing agent, a surfactant, and a corrosion inhibitor. In some embodiments, the composition further comprises one or more of an adhesion promoter, a defoamer, and a surfactant.

In some embodiments, any one of the ink jet ink compositions described herein does not comprise water. In some embodiments, any one of the ink jet ink compositions described herein comprise less than about 1% water by weight of the composition. In some embodiments, any one of the ink jet ink compositions described herein comprise less than about 5% water by weight of the composition.

In some embodiments, any one of the ink jet ink compositions described herein composition has a viscosity of from about 3.0 to about 5.0 cP at about 25° C. In some embodiments, any one of the ink jet ink compositions described herein has a electrical resistivity of from about 1000 to about 1500 ohm-cm at about 25° C.

In some embodiments, the ink jet ink composition comprises:
(i) about 6% w/w of an organic pigment;
(ii) about 75% w/w to about 85% w/w of a solvent;
(iii) about 7% w/w of a binder resin;
(iv) about 1% w/w of a conductive agent;
(v) optionally, a surfactant;
(vi) optionally, a dispersing agent; and
(vii) optionally, a corrosion inhibitor.

In some embodiments, (i) the organic pigment is C.I. pigment yellow 139; (ii) the solvent comprises one or more selected from methyl ethyl ketone, butyl lactate, and propylene glycol methyl ether acetate; (iii) the binder resin comprises one or more of vinyl chloride/vinyl acetate copolymers (VINNOL® E 15/45M TF), cellulose-based resins (CAP 482-0.5), and rosin ester resins (STAYBELITE® Ester 10); (iv) the conductive agent is tetrabutylammonium hexafluorophosphate; (v) the surfactant is present and comprises a silicone surfactant (BYK® 3550); (vi) the dispersing agent is present and comprises a polymeric dispersant (SOLSPERSE™ 38500); and (vii) the corrosion inhibitor is present and comprises benzotriazole.

In some embodiments, the ink jet ink composition comprises:
(i) about 8% w/w of an organic pigment;
(ii) about 70% w/w to about 80% w/w of a solvent;
(iii) about 7% w/w of a binder resin;
(iv) about 1% w/w of a conductive agent; and
(v) optionally, a surfactant.

In some embodiments, (i) the organic pigment is C.I. pigment yellow 139; (ii) the solvent comprises one or more of methyl ethyl ketone, butyl lactate, and propylene glycol methyl ether acetate; (iii) the binder resin comprises one or more vinyl chloride/vinyl acetate copolymers (VINNOL® E 15/45M TF) and rosin ester resins (STAYBELITE® Ester 10); (iv) the conductive agent is tetrabutylammonium hexafluorophosphate; and (v) the surfactant is present and comprises a silicone surfactant (BYK® 3550).

In some embodiments, the ink jet ink composition comprises:
(i) about 5% w/w of an organic pigment;
(ii) about 65% w/w to about 75% w/w of a solvent;
(iii) about 21% w/w of a binder resin;
(iv) about 1.5% w/w of a conductive agent;
(v) optionally, a surfactant; and
(vi) optionally, an adhesion promoter.

In some embodiments, (i) the organic pigment is C.I. pigment yellow 139; (ii) the solvent comprises one or more of methyl ethyl ketone and propylene glycol methyl ether acetate; (iii) the binder resin comprises one or more of cellulose-based resins (CAP 482-0.5), acrylic resins (JONCRYL® 611) and silicone resins (SILRES® 604 or DOWSIL™ RSN-0233); (iv) the conductive agent is tetrabutylammonium hexafluorophosphate; (v) the surfactant is present and comprises a silicone based surfactant (SILWET® L7622); and (vi) the adhesion promoter is present and comprises a silane adhesion promoter (WETLINK 78).

In some embodiments, the ink jet ink composition comprises:
(i) about 8% w/w of an organic pigment;
(ii) about 55% w/w to about 65% w/w of a solvent;
(iii) about 21% w/w of a binder resin;
(iv) about 2% w/w of a conductive agent;
(v) optionally, a surfactant; and
(vi) optionally, an adhesion promoter.

In some embodiments, (i) the organic pigment is C.I. pigment yellow 139; (ii) the solvent comprises one or more of methyl ethyl ketone and propylene glycol methyl ether acetate; (iii) the binder resin comprises one or more of acrylic resins (JONCRYL® 611) and silicone resins (SILRES® 604 or DOWSIL™ RSN-0233); (iv) the conductive agent is tetrabutylammonium hexafluorophosphate; (v) the surfactant is present and comprises a silicone based surfactant (SILWET® L7622); and (vi) the adhesion promoter is present and comprises a silane adhesion promoter (WETLINK 78).

In some embodiments, the ink jet ink composition comprises:
(i) about 6% w/w of an organic pigment;
(ii) about 65% w/w to about 75% w/w of a solvent;
(iii) about 14% w/w of a binder resin;
(iv) about 1.5% w/w of a conductive agent;
(v) optionally, a surfactant;
(vi) optionally, an adhesion promoter; and
(vii) optionally, a plasticizer.

In some embodiments, (i) the organic pigment is C.I. pigment yellow 139; (ii) the solvent comprises one or more of methyl ethyl ketone, ethanol, propylene glycol, and propylene glycol methyl ether acetate; (iii) the binder resin comprises one or more acrylic resins (JONCRYL® 586 and CARBOSET® 527); (iv) the conductive agent is tetrabutylammonium hexafluorophosphate; (v) the surfactant is present and comprises a siloxane surfactant (ELEMENT14™ PDMS100); (vi) the adhesion promoter is present and comprises a silane adhesion promoter (WETLINK 78) and a polyamine adhesion promoter (polyethyleneimine); and (vii) the plasticizer is present and comprises a sulfonamide plasticizer (RIT-CIZER™ 8).

In some embodiments, the organic pigment is formulated as a dispersion comprising about 48% w/w of the organic pigment.

### BRIEF DESCRIPTION OF THE DRAWINGS

FIG. 1 illustrates the opacity and contrast of Comparative Example and Examples 1, 2, and 4.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Described herein are soft pigmented continuous ink jet ink compositions comprising an organic pigment, a solvent, a binder resin, and a conductive agent, wherein the organic pigment has a certain particle size and distribution that provides excellent opacity and printer reliability in a CIJ printer, including a dye-based CIJ printer. Specifically, this disclosure recognizes that a particle size within the 100 to 300 nm range (e.g., a particle size mean of about 100 nm to about 230 nm and a cumulative 99% particle diameter (D99) of less than about 600 nm), provides excellent opacity or hiding power on dark substrates and provides great contrast without the use of inorganic pigments such as TiO₂. As demonstrated in the Examples, the organic pigmented ink compositions described herein also work well in a regular dye-based printer with breakoff stability and printer uptime that are better those achieved with conventional pigmented inks.

Provided in one aspect is an ink jet ink composition comprising:
an organic pigment,
a solvent,
a binder resin, and
a conductive agent,
   wherein the organic pigment comprises particles having a particle size mean of about 100 nm to about 230 nm and a cumulative 99% particle diameter (D99) of less than about 600 nm.

Provided in another aspect is an ink jet ink composition comprising:
an organic pigment,
a solvent,
a binder resin, and
a conductive agent,
   wherein the organic pigment comprises particles having a particle size mean of about 100 nm to about 200 nm and a cumulative 99% particle diameter (D99) of less than about 600 nm.

### Particle Size and Distribution

The organic pigments described herein comprise particles having a particle size mean of about 120 nm to about 230 nm, including about 120 nm, about 130 nm, about 140 nm, about 150 nm, about 160 nm, about 170 nm, about 180 nm, about 190 nm, about 200 nm, about 210 nm, about 220 nm, and about 230 nm. Also, the organic pigments described herein comprises particles having a cumulative 99% particle diameter (D99) of less than about 600 nm, including less than about 550 nm, less than about 510, less than about 500, less than about 450 nm, less than about 400 nm, less than about 350 nm.

In some embodiments, the organic pigment comprises particles having a particle size mean of about 120 nm to about 230 nm and a cumulative 99% particle diameter (D99) of less than about 500 nm. In some embodiments, the organic pigment comprises particles having a particle size mean of about 150 nm to about 230 nm and a cumulative 99% particle diameter (D99) of less than about 500 nm. In some embodiments, the organic pigment comprises particles having a particle size mean of about 120 nm to about 200 nm and a cumulative 99% particle diameter (D99) of less than about 500 nm. In some embodiments, the organic pigment comprises particles having a particle size mean of about 150 nm to about 200 nm and a cumulative 99% particle diameter (D99) of less than about 500 nm. In some embodiments, the organic pigment comprises particles having a particle size mean of about 170 nm and a cumulative 99% particle diameter (D99) of less than about 500 nm. In some embodiments, the organic pigment comprises particles having a particle size mean of about 120 nm to about 200 nm and a cumulative 99% particle diameter (D99) of less than about 600 nm. In some embodiments, the organic pigment comprises particles having a particle size mean of about 120 nm to about 200 nm and a cumulative 99% particle diameter (D99) of less than about 510 nm. In some embodiments, the organic pigment comprises particles having a particle size mean of about 170 nm and a cumulative 99% particle diameter (D99) of less than about 510 nm.

The preferred method for calculating the particle size mean is to derive it from the volume weighted distribution using a Gaussian fit of output from a dynamic light scattering type particle sizing instrument. In all instances, the term “size” refers to the diameter of the particles.

### Organic Pigments

The ink jet ink compositions described herein comprise an organic pigment or a combination of pigments. Suitable organic pigments include yellow organic pigment, an orange organic pigment, or a red organic pigment with any known C.I. Number or CAS Number. Examples of such organic pigments include Pigment Yellow 83 or PY83 (C.I. 21108), PY138 (C.I. 56300), PY139 (C.I. 56298), PY151 (C.I. 13980), PY170 (C.I. 21104), PY181 (C.I. 11777), PY194 (C.I. 11785); Pigment Orange 36 or PO36 (C.I. 11780), PO34 (C.I. 21115), PO64 (C.I. 12760); Pigment Red 146 or PR146 (C.I. 12485) and PR170 (C.I. 12475).

In some embodiments, the organic pigment is a yellow organic pigment. Suitable yellow pigments include any of the general classes of, but are not limited to, azo or monoazo yellow pigments or metal complexes thereof, such as C.I. Pigment Yellows 1, 3, 5, 6, 9, 10, 12, 14, 16, 17, 55, 61, 62, 63, 65, 74, 75, 77, 81, 83, 87, 93, 94, 95, 97, 98, 104, 105, 111, 113, 116, 120, 126, 127, 128, 130, 133, 134, 136, 165, 166, 168, 169, 170, 172, 174, 176,183, 190, 191, 200, 204; anthraquinone yellow pigments such as C.I. Pigment Yellows 24, 147, 150, 151, 152, 193; isoindolinone yellows such as C.I. Pigment Yellows 109, 110, 138, 139, 173; azomethines and metal complexes thereof such as C.I. Pigment Yellow 129; dioxime metal complexes such as C.I. Pigment Yellow 153, and, benzimidazolone yellows such as C.I. Pigment Yellows 154, 155, 156, 175, 180, 181, 194. The yellow pigment may preferably be a benzimidazolone pigment or an isoindolinone pigment. A preferred class of red-shade yellow pigments are isoindolinone yellows, such as C.I. Pigment Yellow 139.

In some embodiments, the organic pigment is a yellow organic pigment, an orange organic pigment, or a red organic pigment. In some embodiments, the organic pigment is a yellow organic pigment selected from one or more of C.I. pigment yellow 83, C.I. pigment yellow 138, C.I. pigment yellow 139, C.I. pigment yellow 151, C.I. pigment yellow 170, C.I. pigment yellow 181, and C.I. pigment yellow 194. In some embodiments, the yellow organic pigment is C.I. pigment yellow 139.

Pigments that exhibit a high degree of opacity are preferred in several embodiments. Without being bound by theory, the pigments may exhibit greater or lesser opacity also due to their individual particle shape or structure. It is believed that opaque red, orange or yellow pigments are less isometric in shape than non-opaque pigments and therefore these kinds of pigmented inks may benefit in particular by reducing the average particle size thereby increasing the degree of isometry.

In some embodiments, the organic pigment is present in amount of from about 1% to about 15% by weight of the composition, including about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, and about 13% by weight of the composition. In some embodiments, the organic pigment is present in amount of from about 3% to about 15% by weight of the composition. In some embodiments, the organic pigment is present in amount of from about 3% to about 10% by weight of the composition. In some embodiments, the organic pigment is present in amount of from about 3% to about 8.5% by weight of the composition.

The pigmented ink may be formulated by any means that is conventional including being directly let down into the ink vehicle or first by formulation in a dispersion which is processed to achieve the desired, stable particle size.

In some embodiments, the organic pigment is formulated as a dispersion comprising about 48% w/w of the organic pigment and about 32% of w/w propylene glycol methyl ether acetate as the solvent. In some embodiments, the ink jet ink compositions described herein comprises from about 5% w/w to about 20% w/w of the pigment dispersion comprising the organic pigment, including from about 5%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, about 13%, about 13.5%, about 14%, about 14.5%, about 15%, about 15.5%, about 16%, about 16.5%, about 17%, about 17.5%, about 18%, about 18.5%, about 19, about 19.5%, and about 20% w/w.

The dispersion may also include any suitable dispersing agents, processing aids, defoamers, wetting agents, resins, etc. that lend to a stable dispersion and achieve the final properties desired on let down into the ink. In the main embodiments, the ink and the dispersion both exhibit the same or very similar key properties such as average particle size, a particle size distribution, and pigment specific gravity so the exact composition of the dispersion is not critical. For example, when sampling the dispersion, the mean size may be between about 120 nm to about 230 nm. For the ink measured size will remain within the same range after letting down the pigment dispersion.

### Solvents

The ink jet ink compositions described herein comprise a solvent. Suitable examples include but are not limited to one or more of ketones, esters, alcohols, glycols, glycol ethers, glycol ether acetates, and glycol ether esters. Suitable examples of ketones include but are not limited to acetone, methyl ethyl ketone, 3-methyl-2-butanone (methyl isopropyl ketone), 2-pentanone (methyl propyl ketone), diethyl ketone, methyl isobutyl ketone, cyclopentanone, and cyclohexanone. Suitable examples of esters include but are not limited to methyl acetate, ethyl acetate, n-propyl acetate, isopropyl acetate, n-butyl acetate, t-butyl acetate, amyl acetate, methyl lactate, ethyl lactate, n-propyl lactate, isopropyl lactate, n-butyl lactate, and methoxypropyl acetate. Suitable examples of alcohols include but are not limited to methanol, ethanol, n-propanol, isopropanol, n-butanol, t-butanol, n-pentanol, and n-hexanol. Suitable examples of glycols include but are not limited to ethylene glycol, propylene glycol, glycerin, and diethylene glycol. Suitable examples of glycol ethers or glycol ether acetates include but are not limited to methoxypropanol, dipropylene glycol methyl ether, propylene glycol propyl ether, propylene glycol butyl ether, tripropylene glycol methyl ether, butylene glycol methyl ether, dibutylene glycol methyl ether, dipropylene glycol methyl ether acetate, propylene glycol propyl ether acetate, propylene glycol butyl ether acetate.

In some embodiments, the solvent comprises one or more of ketones, esters, alcohols, lactates, glycols, glycol ethers, glycol ether acetates, glycol ether acetates and glycol ether esters. In some embodiments, the solvent comprises one or more of acetone, butanone (methyl ethyl ketone), 3-methyl-2-butanone (methyl isopropyl ketone), 2-pentanone (methyl propyl ketone), 3-pentanone (diethyl ketone), cyclopentanone, cyclohexanone, ethanol, propanol, 2-propanol (isopropanol), 1-butanol, 2-butanol, methyl acetate, ethyl acetate, methyl lactate, ethyl lactate, butyl lactate, propylene glycol, and propylene glycol methyl ether acetate.

In some embodiments, the solvent is present in an amount of at least about 50% by weight of the composition, including at least about 55%, at least about 60%, at least about 65%, at least about 70%, at least about 75%, at least about 80%, at least about 85%, at least about 90%. In some embodiments, the solvent is present in an amount of from about 50% to about 90% by weight of the composition, including about 50%, about 55%, about 60%, about 65%, about 70%, about 75%, about 80%, about 85%, and about 90%. In some embodiments, the solvent is present in an amount of from about 60% to about 80% by weight of the composition.

In some embodiments, any one of the ink jet ink compositions described herein does not comprise water. In some embodiments, any one of the ink jet ink compositions described herein comprise less than about 1% water by weight of the composition, including about 0.05%, about 0.1%, about 0.2%, about 0.3%, about 0.4%, about 0.5%, about 0.6%, about 0.7%, about 0.8%, about 0.9%, and about 1%. In some embodiments, any one of the ink jet ink compositions described herein comprise less than about 5% water by weight of the composition, including about 0.05%, about 0.1%, about 0.5%, about 1%, about 1.5%, about 2%, about 2.5%, about 3%, about 3.5%, about 4%, about 4.5%, and about 5%. In some embodiments, any one of the ink jet ink compositions described herein comprise from about 0.05% to about 1% water by weight of the composition.

### Binder Resin

The ink jet ink compositions described herein comprise a binder resin. Binder resins may be used to provide ink adhesion on substrates, thus preventing the damage or loss of the printed marks from the marked surface in product handling after marking. These binder resins may be employed with co-resins. Suitable examples of binder resins include one or more of binder resin comprises one or more of acrylic resins, vinyl chloride/vinyl acetate copolymers, polyesters, polyvinylbutyral resins, cellulose-based resins, polyurethane resins, silicone resins, modified rosin resins, phenolic resins, polyamide resins, cellulose ester resins, cellulose nitrate resins, polymaleic anhydride resins, acetal polymers, styrene/methacrylate copolymers, aldehyde resins, copolymers of styrene and allyl alcohols, epoxies, polyhydroxystyrenes and polyketone resins.

Acrylic resins may be a homopolymer or incorporate two or more monomers with or without specific functional groups. Functionalized acrylic resins may be derived from an alkyl type monomer, such as a methacrylate, plus a functionalized monomer, such as acrylic acid or methacrylic acid; basic monomers such as amino acrylates; or neutral functional monomers that contain hydroxyl groups. Examples of suitable resins are those from Dow Chemical Corporation sold under the trade-name ACRYLOID or PARALOID. Suitable specific resins include DIANAL® PB-204, TB-221, TB-103, and PB-383 resins from Dianal Corporation (a Division of Mitsubishi Chemical Corporation). Other suitable acrylic resins are CARBOSET® 525, 527, and 514A resins available from Lubrizol, and NEOCRYL® B-725, B-731, B-735, B-810, B-811, B-813, B-814, B-817, B-818, B-842, B-890, and B-891 resins, available from Covestro AG and ELVACITE 2669 and 2776 available from Mitsubishi Chemical. A specific example of a non-functionalized resin is sold under the trade name PARALOID B-60, which is a methylmethacrylate and butylmethacrylate copolymer with a molecular weight of approximately 50,000 Daltons.

Other suitable acrylic resins and styrene acrylic resins include those having weight average molecular weights less than about 100,000. Other resins are ones that incorporate pendant amine groups as is disclosed in U.S. Pat. No. 4,892,775.

Examples of acrylic resins also include styrene-acrylic resins which can be made by copolymerizing styrene with acrylic monomers such as acrylic acid or methacrylic acid, and optionally, with alkyl acrylate monomers, such as methyl acrylate, methyl methacrylate, butyl acrylate, butyl methacrylate, hydroxyethyl acrylate, hydroxyethyl methacrylate, and the like made by BASF, under the trade name JONCRYL®. Examples of JONCRYL® resins include JONCRYL® 555, 586, 611, 678, 680, 682, 683, 690, 693, and 67.

Suitable resins comprising vinyl acetate/vinyl chloride copolymers those under the trade name of VINNOL from Wacker Chemie, Inc. These include structurally modified carboxyl-vinyl chloride/vinyl acetate polymers (e.g., VINNOL® E15/45M), hydroxyl-modified vinyl chloride/vinyl acetate polymers (e.g., VINNOL® E15/40A), and unmodified vinyl chloride/vinyl acetate polymers (e.g., VINNOL® H14/36). Vinyl acetate/vinyl chloride copolymers with any structural modifications or ratio of vinyl chloride:vinyl acetate may be employed, as long as they are soluble in the carrier.

Examples of polyvinylbutyral resins are PIOLOFORM® BN 18, available from Wacker Chemie AG, and MOWITAL® B20H available from Kuraray America, Inc. Examples of ethyl cellulose resins are ETHOCEL available from Dow Chemical. Another example of a cellulose-based resin is CAP-482-0.5 (cellulose acetate propionate) from Eastman Chemical.

Suitable polyurethane resins include those comprising flexible thermoplastic urethanes produced by the reaction of diols and diisocyanates. Examples of diols include ethylene glycol, propylene glycol, propanediol, butanediol, polyethylene glycol, polypropylene glycol, polyethylene glycol adipate diol, polyethylene glycol succinate diol, polytetrahydrofuran diol, and the like. Examples of diisocyanates include 2,4-toluene diisocyanate, 2,6-toluene diisocyanate, 4,4-diphenylmethane diisocyanate, hexamethylene diisocyanate, and the like. Suitable polyurethane resins include those having weight average molecular weights in the range of about 4,000 to about 25,000. Specific examples of polyurethane resins include those sold under the commercial name of SURKOPAK® by BIP (Oldbury) Limited. A variety of grades of polyurethane solutions are sold under this name and include SURKOPAK® 2135, SURKOPAK® 5299, SURKOPAK® 5244, SURKOPAK® 5255, SURKOPAK® 2X, SURKOPAK® 5322, SURKOPAK® 5311, and SURKOPAK® XL. SURKOPAK® 5322 is a polyurethane composed of polypropylene glycol and 4,4′-diphenylmethane diisocyanate and is sold a solution in a mixed solvent containing ethyl acetate and isopropanol.

Silicone resins include, but are not limited to, dimethyl silicone resin, methyl phenyl silicone resin, and methyltrifluoropropyl silicone resin. Silicone resins are commercially available from Dow Chemical Corp. and GE Silicones, and Wacker Silicones, Corp. Exemplary silicone resins include the silicone resin DOWSIL™ RSN-0233, which is a polysiloxane having methyl (48%), phenyl (44%), hydroxyl (4%), O-butyl (2%), and O-propyl (1%) substituents. Also contemplated for use SILRES® 604 from Wacker Chemie AG.

Rosin ester resins include SUPERESTER 75 available from Arakawa Chemical and STAYBELITE® Ester 10, which is the glycerol ester of partially hydrogenated wood rosin from Pinova Incorporated or equivalent grades available from Eastman Chemical Corporation.

In some embodiments, the binder resin comprises one or more of acrylic resins, vinyl chloride/vinyl acetate copolymers, polyesters, polyvinylbutyral resins, cellulose-based resins, polyurethane resins, silicone resins, modified rosin resins, phenolic resins, polyamide resins, cellulose ester resins, cellulose nitrate resins, polymaleic anhydride resins, acetal polymers, styrene/methacrylate copolymers, aldehyde resins, copolymers of styrene and allyl alcohols, epoxies, polyhydroxystyrenes and polyketone resins. In some embodiments, the binder resin comprises one or more of acrylic resins, vinyl chloride/vinyl acetate copolymers, silicone resins, modified rosin resins, and cellulose ester resins.

In some embodiments, the binder resin is present in an amount of from about 5% to about 25% by weight of the composition.

### Conductive Agent

The ink jet ink compositions described herein comprise a conductive agent, which can act as a charge carrier in the liquid ink to achieve a desired resistivity. Suitable conductive agents include ammonium or phosphonium salts, and borate and phosphate salts. Other examples of suitable conductive agents include ammonium, alkali, and alkaline earth metal salts such as lithium nitrate, lithium thiocyanate, lithium trifluoromethanesulfonate, potassium bromide, and the like; amine salts such as dimethylamine hydrochloride, and hydroxylamine hydrochloride; tetraalkylammonium salts such as tetrabutylammonium chloride, tetrabutylammonium bromide, tetrabutylammonium acetate, tetrabutylammonium nitrate, tetrabutylammonium hexafluorophosphate, tetrabutylammonium tetrafluoroborate, tetrabutylammonium thiocyanate, tetrapropylammonium chloride, tetrapropylammonium bromide, tetrapropylammonium acetate, tetrapropylammonium nitrate, tetrapropylammonium hexafluorophosphate, tetapropylammonium tetrafluoroborate, tetrapropylammonium thiocyanate, tetraethylammonium chloride, tetraethylammonium bromide, tetraethylammonium acetate, tetraethylammonium nitrate, tetraethylammonium hexafluorophosphate, tetraethylammonium tetrafluoroborate, tetraethylammonium thiocyanate, tetramethylammonium chloride, tetramethylammonium bromide, tetramethylammonium acetate, tetramethylammonium nitrate, tetramethylammonium hexafluorophosphate, tetramethylammonium tetrafluoroborate, tetramethylammonium thiocyanate, tetrabutylphosphonium chloride, tetrabutylphosphonium bromide, tetrabutylphosphonium acetate, tetrabutylphosphonium nitrate, tetrabutylphosphonium hexafluorophosphate, tetrabutylphosphonium tetrafluoroborate, tetrabutylphosphonium thiocyanate, tetrapropylphosphonium chloride, tetrapropylphosphonium bromide, tetrapropylphosphonium acetate, tetrapropylphosphonium nitrate, tetrapropylphosphonium hexafluorophosphate, tetrapropylphosphonium tetrafluoroborate, tetrapropylphosphonium thiocyanate, tetraethylphosphonium chloride, tetraethylphosphonium bromide, tetraethylphosphonium acetate, tetraethylphosphonium nitrate, tetraethylphosphonium hexafluorophosphate, tetraethylphosphonium tetrafluoroborate, tetraethylphosphonium thiocyanate, tetramethylphosphonium chloride, tetramethylphosphonium bromide, tetramethylphosphonium acetate, tetramethylphosphonium nitrate, tetramethylphosphonium hexafluorophosphate, tetramethylphosphonium tetrafluoroborate, tetramethylphosphonium thiocyanate, tetraphenylphosphonium chloride tetraphenylphosphonium bromide, tetraphenylphosphonium acetate, tetraphenylphosphonium nitrate, tetraphenylphosphonium hexafluorophosphate, tetraphenylphosphonium tetrafluoroborate, tetraphenylphosphonium thiocyanate as well as ammonium acetate. In some embodiments, the conductive agent comprises a cation selected from the group consisting of tetraalkylammonium, tetraarylammonium, tetraalkylphosphonium, tetraarylphosphonium, and any combinations thereof, and an anion selected from the group consisting of hexafluorophosphate, tetrafluoroborate, tetraalkylborate, tetraarylborate, and any combinations thereof. Examples of specific conductive agents include but are not limited to tetrabutylammonium hexafluorophosphate, tetrapropylammonium hexafluorophosphate, tetraethylammonium hexafluorophosphate, tetramethylammonium hexafluorophosphate, tetrabutylammonium tetraphenylborate, tetrabutylammonium tetrabutylborate, tetrabutylammonium tetrafluoroborate, tetrapropylammonium tetrafluoroborate, tetraethylammonium tetrafluoroborate, tetramethylammonium tetrafluoroborate, and any combinations thereof. The conductive agent may comprise an alkyl ammonium salt. An alkyl ammonium salt may comprise at least one aliphatic alkyl chain having at least three carbon atoms in combination with groups with varying carbon atom content such as methyl groups. For example, in some embodiments, the conductive agent comprises one or more of didecyldimethylammonium chloride, diallyldimethylammonium chloride, and cetyltrimethylammonium bromide. A blend of conductive agents may be used to improve processibility or stability.

In some embodiments, the conductive agent comprises one or more of tetrabutylammonium hexafluorophosphate, tetrapropylammonium hexafluorophosphate, tetraethylammonium hexafluorophosphate, tetramethylammonium hexafluorophosphate, tetrabutylammonium tetraphenylborate, and tetrabutylammonium tetrabutylborate. In some embodiments, the conductive agent comprises tetrabutylammonium hexafluorophosphate.

In some embodiments, the conductive agent is present in an amount of from about 0.5% to about 5% by weight of the composition, including about 0.5%, about 1%, about 1.5%, about 2%, about 2.5%, about 3%, about 3.5%, about 4%, about 4.5%, and about 5%. In some embodiments, the conductive agent is present in an amount of from about 1% to about 2% by weight of the composition.

### Additional Components

In some embodiments, any one of the ink jet ink compositions described herein further comprises one or more of a humectant, a co-solvent, a co-resin, a defoamer, an adhesion promoter, a plasticizer, a dispersing agent, a surfactant, and a corrosion inhibitor. In some embodiments, the composition further comprises one or more of an adhesion promoter, a defoamer, and a surfactant.

Humectants may be used to prevent drying of the ink on the print head during the printing operation, as well as during storage of the ink. Humectants are typically hydrophilic solvents having high boiling points, such as above 100° C. or from about 150° C. to about 250° C. Suitable humectants include but are not limited to glycols, such as ethylene glycol, propylene glycol, glycerin, diglycerin, and diethylene glycol; glycol ethers, such as ethylene glycol dimethyl ether, ethylene glycol diethylether, propyleneglycol methylether, cellosolve, diethylene glycol monoethylether (CARBITOL™), diethylene glycol dimethylether, and diethylene glycol diethylether; dialkyl sulfoxides, such as dimethyl sulfoxide; and other solvents such as sulfolane and N-methylpyrrolidone. The humectant can be present in an amount of from about 0.1% to about 10% by weight of the ink composition.

Co-solvents may be employed in the ink jet ink compositions described herein. If a co-solvent is used, it is used in an amount smaller than the main solvent and can be any one of the solvents that are described herein. For example, the main solvent is used in an amount of about two, three, four, five, or more times the amount of the co-solvent.

Co-resins can provide improved dispersability of the pigment and/or stability of the ink composition. An example of a co-resin is an aldehyde resin, such as urea-aldehyde resin or ketone resin.

Defoamers may be used to prevent foaming of the ink during its preparation, as well as during the printing operation. Suitable defoamers include polysiloxane and/or fluoropolymer defoamers, such as BYK™ 065 from BYK-Chemie, in Wallingford, Conn. The defoamer can be present in any suitable amount, for example, in an amount of from about 0.01% to about 1% by weight of the ink composition.

The ink jet ink compositions described herein may comprise an adhesion promoter, such as a silane or a polyamine. Suitable adhesion promoters also include monomeric compounds of low molecular weight, although dimeric, trimeric, or higher oligomeric compounds are also contemplated, and these compounds may optionally contain one or more reactive groups, e.g., epoxy groups. Examples of suitable silanes include SILQUEST® WETLINK 78 (γ-glycidoxypropyl diethoxymethylsilane), SILQUEST® A-link 25 (3-isocyanatopropyltriethoxysilane), SILQUEST® A-Link 35 (3-isocyanatopropyltrimethoxysilane, SILQUEST® Silane A-186 ([3-(3,4-epoxycyclohexyl)ethyltrimethoxysilane), SILQUEST® Silane A-187 (γ-glycidoxypropyl trimethoxysilane) SILQUEST® Silane A-1100 (gamma-aminopropyltriethoxysilane), SILQUEST® Silane A-137 (octyltriethoxysilane) and COATOSIL™ 1770 ([3-(3,4-epoxycyclohexyl)ethyltriethoxysilane), all available from Momentive. Other examples include SIGMASIL SG914 (n-propyltriethoxysilane) available from Sigmasil Chemical Corporation and ADDID 900 (amino-functional trimethoxy silane) and 940 (methacrylic trimethoxy-functional silane), both of which are available from Wacker Silicones Corp and 3-aminopropyltriethoxysilane and 2 (3,4-epoxycyclohexyl)ethyltriethoxysilane both available from Gelest Corporation. Suitable polyamines include polyalkyleneamines (e.g., polyethyleneimine) and may be further modified by ethoxylation, epoxylation, or silylation. Other examples of polyamines include dendrimers and aminoacrylic polymers, such as disclosed in U.S. Pat. Nos. 5,596,027 and 6,221,933. Polyethyleneimines may be obtained commercially and can be of any suitable molecular weight, such as below a weight average molecular weight of about 10,000. The adhesion promoter can be present in any suitable amount, for example, from about 0.01% to about 3% by weight.

Plasticizers may be used to further enhance the properties, e.g., durability, of the printed message. Examples of suitable plasticizers include phthalate plasticizers, e.g., alkylbenzyl phthalates, butylbenzyl phthalate, dioctyl phthalate, diisobutyl phthalate, dicyclohexyl phthalate, diethyl phthalate, dimethyl isophthalate, dibutyl phthalate, and dimethyl phthalate; esters such as di-(2-ethylhexy)-adipate, diisobutyl adipate, glycerol tribenzoate, sucrose benzoate, dibutyl sebacate, dibutyl maleate, polypropylene glycol dibenzoate, neopentyl glycol dibenzoate, dibutyl sebacate, and tri-n-hexyltrimellitate; phosphates such as tricresyl phosphate, dibutyl phosphate, triethyl citrate, tributylcitrate, acetyl tri-n-butyl citrate; polyurethanes; acrylic polymers; lactates; oxidized oils such as epoxidized soybean oil, oxidized linseed oil; and sulfonamide plasticizers, RIT-CIZER 8 (op-mixture of N-ethyltoluenesulfonamide) available from Rit-Chem Co. The plasticizer can be present in any suitable amount, for example, in an amount of from about 0.01% to about 3% by weight of the ink composition.

Dispersing agents, such as polymeric dispersing agents, may be used to enhance pigment stabilization or reduce sedimentation rate. Hyperdispersants, which are polymeric dispersing agents containing groups with affinity for pigments, may also be employed. An example of a hyperdispersant is SOLSPERSE™ 38500 (an active polymeric dispersant in MPA) available fromLubrizol. A suitable dispersing agent includes BYK® P104S from BYK-Chemie. Other examples of hyperdispersants can be found in the literature, for example, see WO00/63305, the disclosure of which is incorporated by reference. In general, suitable dispersing agents include those available under the trade name SOLSPERSE™ from LubriZol, Inc.; the trade name EFKA from BASF, Inc.; and the tradename of BYK or DISPERBYK from BYK Chemie, Inc. The dispersing agent can be used in any suitable amount, for example, in an amount of from about 0.1% to about 5% by weight by weight of the ink composition.

Surfactants may be used to optimize the wetting and/or drying characteristics of the ink. Suitable surfactants include siloxanes, silicones, silanols, polyoxyalkyleneamines, propoxylated (poly(oxypropylene))diamines, alkyl ether amines, nonyl phenol ethoxylates, ethoxylated fatty amines, quaternized copolymers of vinylpyrrolidone and dimethyl aminoethyl methacrylate, alkoxylated ethylenediamines, polyethylene oxides, polyoxyalkylene polyalkylene polyamines amines, polyoxyalkylene polyalkylene polyimines, alkyl phosphate ethoxylate mixtures, polyoxyalkylene derivatives of propylene glycol, polyoxyethylated fatty alcohols, and fluorinated surfactants. Examples of a suitable polymeric silicone based surfactant are sold under the trade name SILWET. Examples of fluorinated surfactants include those sold under the trade name ZONYL from Chemours. Specific examples of suitable surfactants include SILWET® L-7622, which is a polyethyleneoxide modified polydimethylsiloxane, available from Momentive, and FC 430, which is a fluoroaliphatic polymeric ester, available from 3M Co. Another specific example of a surfactant is BYK-3550, which is silicone surfactant. An specific example of a siloxane surfactant is ELEMENT14™ PDMS 100. The surfactant can be present in the ink composition in any suitable amount, for example, in an amount of from about 0.01% to about 2% by weight of the ink composition.

Corrosion inhibitors may be used in the ink jet ink compositions described herein. Suitable corrosion inhibitors include benzotriazole and may be present in amount of from about 0.01% to about 2% by weight of the ink composition.

### Ink Jet Ink Compositions

In some embodiments, the ink jet ink composition comprises:
(i) about 6% w/w of an organic pigment;
(ii) about 75% w/w to about 85% w/w of a solvent;
(iii) about 7% w/w of a binder resin;
(iv) about 1% w/w of a conductive agent;
(v) optionally, a surfactant;
(vi) optionally, a dispersing agent; and
(vii) optionally, a corrosion inhibitor.

In some embodiments, (i) the organic pigment is C.I. pigment yellow 139; (ii) the solvent comprises one or more selected from methyl ethyl ketone, butyl lactate, and propylene glycol methyl ether acetate; (iii) the binder resin comprises one or more of vinyl chloride/vinyl acetate copolymers (VINNOL® E 15/45M TF), cellulose-based resins (CAP 482-0.5), and rosin ester resins (STAYBELITE® Ester 10); (iv) the conductive agent is tetrabutylammonium hexafluorophosphate; (v) the surfactant is present and comprises a silicone surfactant (BYK® 3550); (vi) the dispersing agent is present and comprises a polymeric dispersant (SOLSPERSE™ 38500); and (vii) the corrosion inhibitor is present and comprises benzotriazole.

In some embodiments, the ink jet ink composition comprises:
(i) about 8% w/w of an organic pigment;
(ii) about 70% w/w to about 80% w/w of a solvent;
(iii) about 7% w/w of a binder resin;
(iv) about 1% w/w of a conductive agent; and
(v) optionally, a surfactant.

In some embodiments, (i) the organic pigment is C.I. pigment yellow 139; (ii) the solvent comprises one or more of methyl ethyl ketone, butyl lactate, and propylene glycol methyl ether acetate; (iii) the binder resin comprises one or more vinyl chloride/vinyl acetate copolymers (VINNOL® E 15/45M TF) and rosin ester resins (STAYBELITE® Ester 10); (iv) the conductive agent is tetrabutylammonium hexafluorophosphate; and (v) the surfactant is present and comprises a silicone surfactant (BYK® 3550).

In some embodiments, the ink jet ink composition comprises:
(i) about 5% w/w of an organic pigment;
(ii) about 65% w/w to about 75% w/w of a solvent;
(iii) about 21% w/w of a binder resin;
(iv) about 1.5% w/w of a conductive agent;
(v) optionally, a surfactant; and
(vi) optionally, an adhesion promoter.

In some embodiments, (i) the organic pigment is C.I. pigment yellow 139; (ii) the solvent comprises one or more of methyl ethyl ketone and propylene glycol methyl ether acetate; (iii) the binder resin comprises one or more of cellulose-based resins (CAP 482-0.5), acrylic resins (JONCRYL® 611) and silicone resins (SILRES® 604 or DOWSIL™ RSN-0233); (iv) the conductive agent is tetrabutylammonium hexafluorophosphate; (v) the surfactant is present and comprises a silicone based surfactant (SILWET® L7622); and (vi) the adhesion promoter is present and comprises a silane adhesion promoter (WETLINK 78).

In some embodiments, the ink jet ink composition comprises:
(i) about 8% w/w of an organic pigment;
(ii) about 55% w/w to about 65% w/w of a solvent;
(iii) about 21% w/w of a binder resin;
(iv) about 2% w/w of a conductive agent;
(v) optionally, a surfactant; and
(vi) optionally, an adhesion promoter.

In some embodiments, (i) the organic pigment is C.I. pigment yellow 139; (ii) the solvent comprises one or more of methyl ethyl ketone and propylene glycol methyl ether acetate; (iii) the binder resin comprises one or more of acrylic resins (JONCRYL® 611) and silicone resins (SILRES® 604 OR DOWSIL™ RSN-0233); (iv) the conductive agent is tetrabutylammonium hexafluorophosphate; (v) the surfactant is present and comprises a silicone based surfactant (SILWET® L7622); and (vi) the adhesion promoter is present and comprises a silane adhesion promoter (WETLINK 78).

In some embodiments, the ink jet ink composition comprises:
(i) about 6% w/w of an organic pigment;
(ii) about 65% w/w to about 75% w/w of a solvent;
(iii) about 14% w/w of a binder resin;
(iv) about 1.5% w/w of a conductive agent;
(v) optionally, a surfactant;
(vi) optionally, an adhesion promoter; and
(vii) optionally, a plasticizer.

In some embodiments, (i) the organic pigment is C.I. pigment yellow 139; (ii) the solvent comprises one or more of methyl ethyl ketone, ethanol, propylene glycol, and propylene glycol methyl ether acetate; (iii) the binder resin comprises one or more acrylic resins (JONCRYL® 586 and CARBOSET® 527); (iv) the conductive agent is tetrabutylammonium hexafluorophosphate; (v) the surfactant is present and comprises a siloxane surfactant (ELEMENT14™ PDMS100); (vi) the adhesion promoter is present and comprises a silane adhesion promoter (WETLINK 78) and a polyamine adhesion promoter (polyethyleneimine); and (vii) the plasticizer is present and comprises a sulfonamide plasticizer (RIT-CIZER™ 8).

In some embodiments, the ink jet ink composition comprises:
(i) about 5% w/w of an organic pigment;
(ii) about 65% w/w to about 75% w/w of a solvent;
(iii) about 14.5% w/w of a binder resin;
(iv) about 1.5% w/w of a conductive agent;
(v) optionally, a surfactant;
(vi) optionally, an adhesion promoter; and
(vii) optionally, a plasticizer.

In some embodiments, (i) the organic pigment is C.I. pigment yellow 139; (ii) the solvent comprises one or more of methyl ethyl ketone, ethanol, propylene glycol, and propylene glycol methyl ether acetate; (iii) the binder resin comprises one or more acrylic resins (JONCRYL® 611 and CARBOSET® 527); (iv) the conductive agent is tetrabutylammonium hexafluorophosphate; (v) the surfactant is present and comprises a siloxane surfactant (Element14™ PDMS100); (vi) the adhesion promoter is present and comprises one or more of a silane adhesion promoter (WETLINK 78) and a polyamine adhesion promoter (polyethyleneimine); and (vii) the plasticizer is present and comprises a sulfonamide plasticizer (RIT-CIZER™ 8).

In some embodiments, the ink jet ink composition comprises:
(i) about 6% w/w of an organic pigment;
(ii) about 65% w/w to about 75% w/w of a solvent;
(iii) about 10% to about 15% w/w of a binder resin;
(iv) about 1.5% w/w to about 2.5 w/w of a conductive agent;
(v) optionally, a surfactant;
(vi) optionally, an adhesion promoter;
(vii) optionally, a plasticizer; and
(viii) optionally, water.

In some embodiments, (i) the organic pigment is C.I. pigment yellow 139; (ii) the solvent comprises one or more of methyl propyl ketone, ethanol, and propylene glycol; (iii) the binder resin comprises one or more acrylic resins (JONCRYL® 586, CARBOSET® 527, and ELVACITE 2669); (iv) the conductive agent is tetrabutylammonium hexafluorophosphate; (v) the surfactant is present and comprises a siloxane surfactant (Element14™ PDMS100); (vi) the adhesion promoter is present and comprises one or more of a silane adhesion promoter (n-octyltriethoxysilane) and a polyamine adhesion promoter (polyethyleneimine); (vii) the plasticizer is present and comprises a sulfonamide plasticizer (RIT-CIZER™ 8); and water.

In some embodiments, any one of the ink jet ink compositions described herein composition has a viscosity of from about 2.5 to about 6.0 cP at about 25° C., including about 2.5 cP, about 2.6 cP, about 2.7 cP, about 2.8 cP, about 2.9 cP, about 3.0 cP, about 3.1 cP, about 3.2 cP, about 3.3 cP, about 3.4 cP, about 3.5 cP, about 3.6 cP, about 3.7 cP, about 3.8 cP, about 3.9 cP, about 4.0 cP, about 4.1 cP, about 4.2 cP, about 4.3 cP, about 4.4 cPps, about 4.5 cP, about 4.6 cP, about 4.7 cP, about 4.8 cP, about 4.9 cP, about 5.0 cP, about 5.1 cP, about 5.2 cP, about 5.3 cP, about 5.4 cPps, about 5.5 cP, about 5.6 cP, about 5.7 cP, about 5.8 cP, about 5.9 cP, and about 6.0 cP, at about 25° C. In some embodiments, any one of the ink jet ink compositions described herein composition may have a viscosity of about 3.0 to about 5.0 cP at about 25° C.

In some embodiments, any one of the ink jet ink compositions described herein has a electrical resistivity of about 300 to about 2000 ohm-cm at about 25° C., including about 300, about 350, about 400, about 450, about 500, about 550, about 600, about 650, about 700, about 750, about 800, about 850, about 900, about 950, about 1000, about 1050, about 1100, about 1150, about 1200, about 1250, about 1300, about 1350, about 1400, about 1450, about 1500, about 1550, about 1600, about 1650, about 1700, about 1750, about 1800, about 1850, about 1900, about 1950 and about 2000 ohm-cm at about 25° C. In some embodiments, any one of the ink jet ink compositions described herein has a electrical resistivity of about 1000 to about 1500 ohm-cm at about 25° C.

The present invention, thus generally described, will be understood more readily by reference to the following examples, which are provided by way of illustration and are not intended to be limiting of the present invention.

### EXAMPLES

### Example A

Ink jet ink formulations were prepared in accordance to the components and amounts listed in the below table. The general procedures for preparing these ink jet ink formulations included the following steps: (1) dissolving the resin(s) in the solvent with mixing to provide a solution; (2) adding and dissolving the additive(s) in the solution with mixing; (3) adding the pigment (e.g., in the form of the pigment dispersion) to the above solution with mixing; and (4) filtering the pigment-containing solution through an appropriate filtration set (e.g., 5-micron filter).

The organic pigments that were used to prepare the formulations outlined in the below table were from yellow pigment dispersions. The comparative Example was prepared using TINTERSOL® Yellow TT290, which contains about 60% of Pigment Yellow PY139, about 10% of pigment dispersing resin and dispersant, and about 30% of propylene glycol methyl ether acetate as the solvent. Examples 1-6 are exemplary embodiments that were prepared using Inkjet Yellow Pigment Dispersion 1, which contains about 48% of PY139, about 20% of pigment dispersing resin and dispersant, and about 32% of propylene glycol methyl ether acetate as the solvent.

TABLE 1A
Formulation Components and Amounts for
Comparative Example and Examples 1-5

| Components | Comparative | | | | |
|---|---|---|---|---|---|
| (Function) | Example | Example 1 | Example 2 | Example 3 | Example 4 |
| MEK (Solvent) | 75.30% | 76.51% | 72.90% | 66.95% | 57.10% |
| MPK (Solvent) | — | — | — | — | — |
| Ethanol | — | — | — | — | — |
| (Duplicating | | | | | |
| Fluid #5) | | | | | |
| (Solvent) | | | | | |
| Ethanol | — | — | — | — | — |
| (SDA3C) | | | | | |
| (Solvent) | | | | | |
| Butyl lactate | 2.00% | 2.00% | 2.00% | — | — |
| (Purasolv BL) | | | | | |
| (Solvent) | | | | | |
| Propylene | — | — | — | — | — |
| glycol Solvent) | | | | | |
| Propylene | — | — | — | — | 1.20% |
| glycol methyl | | | | | |
| ether acetate | | | | | |
| (Solvent) | | | | | |
| VINNOL ® E | 5.50% | 3.80% | 5.60% | — | — |
| 15/45M TF | | | | | |
| (Binder Resin) | | | | | |
| CAP 482-0.5 | — | 1.30% | — | 0.85% | — |
| (Binder Resin) | | | | | |
| STAYBELITE | 1.50% | 2.10% | 1.50% | — | — |
| ® Ester 10 | | | | | |
| (Bonder Resin) | | | | | |
| JONCRYL ® | — | — | — | 16.70% | 17.90% |
| 611 (Binder | | | | | |
| Resin) | | | | | |
| JONCRYL ® | — | — | — | — | — |
| 586 (Binder | | | | | |
| Resin) | | | | | |
| CARBOSET ® | — | — | — | — | — |
| 527 (Binder | | | | | |
| Resin) | | | | | |
| EVLACITE | — | — | — | — | — |
| 2669 | | | | | |
| SILRES ® 604 | — | — | — | 3.00% | 3.00% |
| OR DOWSIL ™ | | | | | |
| RSN-0233 | | | | | |
| (Binder Resin) | | | | | |
| BYK ® 3550 | 0.20% | 0.20% | 0.20% | — | — |
| (Surfactant) | | | | | |
| SILWET ® | — | — | — | 0.10% | 0.10% |
| L7622 | | | | | |
| (Surfactant) | | | | | |
| ELEMENT14 | — | — | — | — | — |
| PDMS100 | | | | | |
| (Surfactant) | | | | | |
| WETLINK 78 | — | — | — | 2.00% | 2.00% |
| (Adhesion | | | | | |
| Promoter) | | | | | |
| n-octyltriethoxy- | — | — | — | — | — |
| silane | | | | | |
| (Adhesion | | | | | |
| Promoter) | | | | | |
| Polyethyleneimine | — | — | — | — | — |
| (Adhesion | | | | | |
| Promoter) | | | | | |
| RIT-CIZER ™ 8 | — | — | — | — | — |
| (Plasticizer) | | | | | |
| SOLSPERSE ™ | — | 0.50% | — | — | — |
| 38500 | | | | | |
| (Dispersing | | | | | |
| Agent) | | | | | |
| Benzotriazole | — | 0.09% | — | — | — |
| (Corrosion | | | | | |
| Inhibitor) | | | | | |
| Tetrabutyl- | 1.00% | 1.00% | 1.00% | 1.40% | 1.90% |
| ammonium | | | | | |
| hexafluorophosphate | | | | | |
| (Conductive | | | | | |
| Agent) | | | | | |
| water | — | — | — | — | — |
| TINTERSOL ® | 14.50% | — | — | — | — |
| Yellow TT290 | | | | | |
| (Comparative | | | | | |
| Pigment | | | | | |
| Dispersion) | | | | | |
| Inkjet Yellow | — | 12.50% | 16.80% | 9.00% | 16.80% |
| Pigment | | | | | |
| Dispersion 1 | | | | | |
| Total | 100.00% | 100.00% | 100.00% | 100.00% | 100.00% |
| viscosity, cP | 4.23 | 4.20 | 4.04 | 4.20 | 4.20 |
| resistivity, ohm-cm | 1150 | 1125 | 1137 | 1275 | 1239 |

TABLE 1B
Formulation Components and Amounts for Examples 5-9

| Components | | | | | |
|---|---|---|---|---|---|
| (Function) | Example 5 | Example 6 | Example 7 | Example 8 | Example 9 |
| MEK (Solvent) | 52.83% | 55.80% | — | — | — |
| MPK (Solvent) | — | — | 58.13% | 56.93% | 57.83% |
| Ethanol | 11.00% | 9.50% | — | — | — |
| (Duplicating | | | | | |
| Fluid #5) | | | | | |
| (Solvent) | | | | | |
| Ethanol (SDA3C) | — | — | 10.00% | 10.00% | 10.00% |
| (Solvent) | | | | | |
| Butyl lactate | — | — | — | — | — |
| (Purasolv BL) | | | | | |
| (Solvent) | | | | | |
| Propylene glycol | 5.00% | 5.00% | 0.50% | 0.50% | 2.00% |
| Solvent) | | | | | |
| Propylene glycol | — | — | — | — | — |
| methyl ether | | | | | |
| acetate (Solvent) | | | | | |
| VINNOL ® E | — | — | — | — | — |
| 15/45M TF | | | | | |
| (Binder Resin) | | | | | |
| CAP 482-0.5 | — | — | — | — | — |
| (Binder Resin) | | | | | |
| STAYBELITE ® | — | — | — | — | — |
| Ester 10 (Bonder | | | | | |
| Resin) | | | | | |
| JONCRYL ® 611 | — | 10.50% | — | — | — |
| (Binder Resin) | | | | | |
| JONCRYL ® 586 | 9.90% | — | 9.40% | 8.70% | 9.00% |
| (Binder Resin) | | | | | |
| CARBOSET ® | 4.00% | 4.00% | 3.80% | 3.50% | — |
| 527 (Binder | | | | | |
| Resin) | | | | | |
| EVLACITE 2669 | — | — | — | — | 3.00% |
| SILRES ® 604 | — | — | — | — | — |
| OR DOWSIL ™ | | | | | |
| RSN-0233 | | | | | |
| (Binder Resin) | | | | | |
| BYK ® 3550 | — | — | — | — | — |
| (Surfactant) | | | | | |
| SILWET ® L7622 | — | — | — | — | — |
| (Surfactant) | | | | | |
| ELEMENT14 | 0.02% | 0.20% | 0.02% | 0.02% | 0.02% |
| PDMS100 | | | | | |
| (Surfactant) | | | | | |
| WETLINK 78 | 0.50% | 0.50% | — | — | — |
| (Adhesion | | | | | |
| Promoter) | | | | | |
| n-octyltriethoxy- | — | — | 0.50% | — | 0.50% |
| silane (Adhesion | | | | | |
| Promoter) | | | | | |
| Polyethyleneimine | 0.15% | 0.20% | 0.15% | 0.15% | 0.15% |
| (Adhesion | | | | | |
| Promoter) | | | | | |
| RIT-CIZER ™ 8 | 3.00% | 3.00% | 2.90% | 5.90% | 2.90% |
| (Plasticizer) | | | | | |
| SOLSPERSE ™ | — | — | — | — | — |
| 38500 | | | | | |
| (Dispersing | | | | | |
| Agent) | | | | | |
| Benzotriazole | — | — | — | — | — |
| (Corrosion | | | | | |
| Inhibitor) | | | | | |
| Tetrabutyl- | 1.30% | 1.30% | 2.20% | 1.90% | 2.20% |
| ammonium | | | | | |
| hexafluorophosphate | | | | | |
| (Conductive | | | | | |
| Agent) | | | | | |
| water | — | — | 0.10% | 0.10% | 0.10% |
| TINTERSOL ® | — | — | — | — | — |
| Yellow TT290 | | | | | |
| (Comparative | | | | | |
| Pigment | | | | | |
| Dispersion) | | | | | |
| Inkjet Yellow | 12.30% | 10.00% | 12.30% | 12.30% | 12.30% |
| Pigment | | | | | |
| Dispersion 1 | | | | | |
| Total | 100.00% | 100.00% | 100.00% | 100.00% | 100.00% |
| viscosity, cP | 4.20 | 4.40 | 4.1 | 3.9 | 3.8 |
| resistivity, ohm-cm | 1275 | 1341 | 1201 | 1302 | 1174 |

### Example B

The pigment sizes and size distributions of the pigment dispersions that were used to formulate the ink jet ink formulations in the previous example were measured with a Nicomp Model 370 Submicron Particle Sizer from Particle Sizing Systems employing software CW380 Version 1.51a. For the light scattering measurements, a single modal Gaussian distribution was assumed based on favorable chi squared values and the volume weighted mean diameter (e.g., the particle size) was recorded along with the cumulative volume weighted diameter for 99% of the population (D99).

The results are shown in the below table for a number of batches, each of which is produced independently over a given timeframe. As shown on average, TINTERSOL® Yellow TT290, which is PY139 dispersion from Venator Materials Corporation, has typical particle size mean about 297 nm and D99 of about 899 nm. In contrast, Inkjet Yellow Pigment Dispersion 1, which is also a dispersion of PY139, on average has a pigment particle size mean of about 172 nanometres (nm) and 99% of the particles are less than about 465 nm (D99).

TABLE 2
Particle Size of Pigment Dispersion

| Pigment | total # of | Mean diameter (nm) | | | Cumulative D99 (nm) | | |
|---|---|---|---|---|---|---|---|
| dispersion | batches tested | Average | Min | Max | Average | Min | Max |
| TINTERSOL ® | 51 | 297 | 242 | 388 | 899 | 687 | 1203 |
| Yellow TT290 | | | | | | | |
| Inkjet Yellow | 12 | 172 | 162 | 185 | 465 | 431 | 503 |
| Dispersion 1 | | | | | | | |

The pigment particle size in the ink was checked for Examples 1, 8 and 9 and found to be 191, 178 nm and 184 nm respectively, which serves to demonstrate that the particle sizes remain approximately the same after letting down a dispersion into the ink.

### Example C—Print Phase Window Comparison

Print phase window can be used to assess operational reliability of a CIJ ink in a CIJ printer. The number of phases that the printer uses to produce good print quality codes is ink dependent. Generally a minimum of 5 good phases is required for a ink to provide good print quality and operable reliably in a Videojet CIJ printer. A higher number of good phases for a given ink is a direct result of more stable breakoff and translates directly into better operational reliability.

The print phase window can be determined by printing an ink with a range of different phase offsets/angles from the printer selected center phase, and assessing the print quality of each printed sample. Totaling the number of phase offsets that yield good print quality is equal to the number of good phases

The print phase window was assessed in the manner as described above, and the results of this study are shown in the below table.

TABLE 3

| | Number of Good Phases |
|---|---|
| Comparative Example | 4 |
| Example 1 | 5 |
| Example 2 | 6 |
| Example 4 | 6 |

The phase windows shown in the above table was determined using a Videojet® 1580 printer, which is a printer that is designed to run dye-based inks with no special accommodations for running pigmented inks.

The phase window stability for Example 8 was studied over a period of time while operating in a Videojet® 1580c printer in an extreme case environment of 45° C. and 80% R.H. The results are shown in Table 4.

TABLE 4

| | Number of Good Phases |
|---|---|
| Example 8 initial | 5 |
| Example 8 after 512 hours | 6 |

Though the 1580c is designed specifically to use soft pigmented inks, the data in Table 4 serve to demonstrate that the inks formulated here will maintain a stable breakoff over a long period of time in actual use.

### Example D—Opacity and Contrast Comparison

The opacity and contrast of a print image was simply assessed and compared by visual comparison, although a more quantitative method can be applied e.g. by using a colorimeter or a spectrophotometer. It is noteworthy that each of the Examples 1-9 contain reduced pigment as compared with the Comparative example (8.7% pigment).

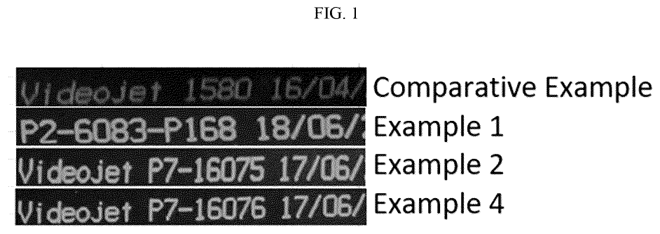

The results of this study are shown in FIG. 1.

The above Examples demonstrate that the ink jet ink compositions formulated in accordance to this disclosure (Examples 1-9) have a wide printing phase window in a dye based CIJ printer with at least 5 good phase, operates reliably in a dye-based printer with good uptime and printer quality, and provides good opacity on a dark surface. In contrast, the comparative ink jet composition (Comparative Example) exhibits lower opacity (poorer contrast on dark substrates) and requires a printer specifically designed for pigmented inks for printer reliability.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An ink jet ink composition suitable for use in a continuous inkjet printing process comprising:
an organic pigment,
a solvent,
a binder resin, and
a conductive agent,
wherein the organic pigment comprises particles having a particle size mean of about 100 nm to about 230 nm and a cumulative 99% particle diameter (D99) of less than about 600 nm.

2. The ink jet ink composition of claim 1, wherein the organic pigment comprises particles having a particle size mean of about 120 nm to about 200 nm.

3. The ink jet ink composition of claim 1, wherein the organic pigment is an orange organic pigment, or a red organic pigment, or a yellow organic pigment, wherein the yellow organic pigment is selected from one or more of C.I. pigment yellow 83, C.I. pigment yellow 138, C.I. pigment yellow 139, C.I. pigment yellow 151, C.I. pigment yellow 170, C.I. pigment yellow 181, and C.I. pigment yellow 194.

4. The ink jet ink composition of claim 1, wherein the organic pigment is present in amount of from about 1% to about 15% by weight of the composition.

5. The ink jet ink composition of claim 1, wherein the solvent comprises one or more of ketones, esters, alcohols, lactates, glycols, glycol ethers, glycol ether acetates, and glycol ether esters, optionally wherein the solvent comprises one or more of methyl ethyl ketone, methyl propyl ketone, diethyl ketone, methyl isopropyl ketone, cyclopentanone, acetone, ethanol, methyl acetate, ethyl acetate, butyl lactate, propylene glycol, and propylene glycol methyl ether acetate.

6. The ink jet ink composition of claim 1, wherein the solvent is present in an amount of at least about 50% by weight of the composition.

7. The ink jet ink composition of claim 1, wherein the binder resin comprises one or more of acrylic resins, vinyl chloride/vinyl acetate copolymers, polyesters, polyvinylbutyral resins, cellulose-based resins, polyurethane resins, silicone resins, modified rosin resins, phenolic resins, polyamide resins, cellulose ester resins, cellulose nitrate resins, polymaleic anhydride resins, acetal polymers, styrene/methacrylate copolymers, aldehyde resins, copolymers of styrene and allyl alcohols, epoxies, polyhydroxystyrenes and polyketone resins.

8. The ink jet ink composition of claim 1, wherein the binder resin is present in an amount of from about 5% to about 25% by weight of the composition.

9. The ink jet ink composition of claim 1, wherein the conductive agent comprises an alkylammonium salt with at least one substituent comprising 4 carbon atoms or more, optionally wherein the conductive agent comprises tetrabutylammonium hexafluorophosphate.

10. The ink jet ink composition of claim 1, wherein the conductive agent is present in an amount of from about 0.5% to about 5% by weight of the composition.

11. The ink jet ink composition of claim 1, further comprising one or more of a humectant, a co-solvent, a co-resin, a defoamer, an adhesion promoter, a plasticizer, a dispersing agent, a surfactant, and a corrosion inhibitor.

12. The ink jet ink composition of claim 1, wherein the composition comprises less than about 1% water by weight of the composition.

13. The ink jet ink composition of claim 1, wherein the composition has a viscosity of from about 3.0 to about 5.0 cP at about 25° C. and/or has an electrical resistivity of from about 1000 to about 1500 ohm-cm at about 25° C.

14. The ink jet ink composition of claim 1, comprising:
(i) about 6% w/w to about 8% w/w of an organic pigment;
(ii) about 70% w/w to about 85% w/w of a solvent;
(iii) about 7% w/w of a binder resin;
(iv) about 1% w/w of a conductive agent;
(v) optionally, a surfactant;
(vi) optionally, a dispersing agent; and
(vii) optionally, a corrosion inhibitor.

15. The ink jet ink composition of claim 14, wherein:
(i) the organic pigment is C.I. pigment yellow 139;
(ii) the solvent comprises one or more selected from methyl ethyl ketone, butyl lactate, and propylene glycol methyl ether acetate;
(iii) the binder resin comprises one or more of vinyl chloride/vinyl acetate copolymers, cellulose-based resins, and rosin ester resins;
(iv) the conductive agent is tetrabutylammonium hexafluorophosphate;
(v) the surfactant is present and comprises a silicone surfactant;
(vi) the dispersing agent is present and comprises a polymeric dispersant (SOLSPERSE™ 38500); and
(vii) the corrosion inhibitor is present and comprises benzotriazole.

16. The ink jet ink composition of claim 1, comprising:
(i) about 5% w/w to about 8% w/w of an organic pigment;
(ii) about 55% w/w to about 75% w/w of a solvent;
(iii) about 21% w/w of a binder resin;
(iv) about 1.5% to about 2% w/w of a conductive agent;
(v) optionally, a surfactant; and
(vi) optionally, an adhesion promoter.

17. The ink jet ink composition of claim 16, wherein:
(i) the organic pigment is C.I. pigment yellow 139;
(ii) the solvent comprises one or more of methyl ethyl ketone and propylene glycol methyl ether acetate;
(iii) the binder resin comprises one or more of cellulose-based resins, acrylic resins and silicone resins;
(iv) the conductive agent is tetrabutylammonium hexafluorophosphate;
(v) the surfactant is present and comprises a silicone based surfactant; and
(vi) the adhesion promoter is present and a silane adhesion promoter.

18. The ink jet ink composition of claim 1, comprising:
(i) about 6% w/w of an organic pigment;
(ii) about 65% w/w to about 75% w/w of a solvent;
(iii) about 14% w/w of a binder resin;
(iv) about 1.5% w/w of a conductive agent;
(v) optionally, a surfactant;
(vi) optionally, an adhesion promoter; and
(vii) optionally, a plasticizer.

19. The ink jet ink composition of claim 18, wherein:
(i) the organic pigment is C.I. pigment yellow 139;
(ii) the solvent comprises one or more of methyl ethyl ketone, ethanol, propylene glycol, and propylene glycol methyl ether acetate;
(iii) the binder resin comprises one or more acrylic resins;
(iv) the conductive agent is tetrabutylammonium hexafluorophosphate;
(v) the surfactant is present and comprises a siloxane surfactant;
(vi) the adhesion promoter is present and comprises a silane adhesion promoter and a polyamine adhesion promoter; and
(vii) the plasticizer is present and comprises a sulfonamide plasticizer.

20. The ink jet ink composition of claim 14, wherein the organic pigment is formulated as a dispersion comprising about 48% w/w of the organic pigment.
